(19) United States
(12) Patent Application Publication
(10) Pub. No.: US 2014/0032455 A1
(43) Pub. Date: Jan. 30, 2014

(54) Evolutionary Scheduling of Utility Consumers

(71) Applicant: GREENWAVE REALITY, PTE, LTD., Singapore (SG)

(72) Inventor: Kong-Wei Lye, Singapore (SG)

(73) Assignee: GREENWAVE REALITY, PTE, LTD., Singapore (SG)

(21) Appl. No.: 13/829,072

(22) Filed: Mar. 14, 2013

Related U.S. Application Data
(60) Provisional application No. 61/675,480, filed on Jul. 25, 2012.

(51) Int. Cl. G06N 3/12

(52) U.S. Cl. CPC G06N 3/126
USPC 706/13

(57) ABSTRACT

A computer-based method to schedule utility consumers includes creating a first generation of vectors using a processor. A vector is made up of a set of operation periods within a time period for consumers of a utility. The method also includes producing, using a processor, one or more successive generations of vectors from the first generation of vectors to create a descendant generation of vectors, and selecting a vector of the descendant generation of vectors based on a fitness function. Then operation periods from the vector of the descendant generation of vectors are provided over a computer communication medium to control operation of the consumers of the utility.

### CROSS-REFERENCE TO RELATED APPLICATIONS

This application claims the benefit of U.S. Prov. Appl. No. 61/675,480 entitled “Evolutionary Computation-based Method for Scheduling Home Devices” filed on Jul. 25, 2012, the entire contents of which are hereby incorporated by reference.

### BACKGROUND

1. Technical Field

The present subject matter relates to scheduling of utility consumers. More specifically it relates to using evolutionary computation for the scheduling of utility consumers.

2. Description of Related Art

Evolutionary computing is a branch of computer science within the broad field of artificial intelligence. Evolutionary computing may provide algorithms for global optimization of problems with metaheuristic or stochastic optimization characteristics. Algorithms within evolutionary computing use iterative progress, such as growth or development in a population, with a selection process to guide that progress. Such algorithms are often inspired by the biological mechanisms of evolution.

Algorithms in evolutionary computing often involve techniques that mimic the mechanisms of biological evolution including reproduction, mutation, natural selection and survival of the fittest. Recombination and mutation are key forces in evolutionary computing systems, creating diverse and novel solutions to the problem of optimization, which may mimic individuals of a population of a biological system which optimizes for survival. Selection processes, such as surviving long enough to mate in natural biological systems, act to determine which solutions, or individuals, are superior to those solutions which die quickly. These selection processes work to increase the quality of the solution over multiple generations.

Many aspects evolutionary processes are random. Certain aspects of multiple solutions may be randomly combined and/or mutated in a new solution. Selection processes can be either deterministic, random, or a combination of both. For example, in nature, healthier individuals within a population are more likely to survive long enough to produce offspring, but some strong individuals may be killed before mating and some weak individuals may live long enough to mate due to random events.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. They should not, however, be taken to limit the invention to the specific embodiment(s) described, but are for explanation and understanding only. In the drawings:

FIG. 1 is a diagram of an embodiment of evolutionary scheduling of utility consumers;

FIG. 2A and 2B show example embodiments of mating parent vectors to create a child vector;

FIG. 3A is a flowchart of an example method of evolutionary scheduling of utility consumers;

FIG. 3B is a flowchart of an example method to produce a next generation of vectors;

FIG. 4 is a diagram of a system for an embodiment of evolutionary scheduling of utility consumers at a utility provider level;

FIG. 5 shows a stylized view of a home for use with an embodiment of evolutionary scheduling of utility consumers; and

FIG. 6 is a block diagram of an example computer system useful for embodiments.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases that may be given meanings differently than their generally accepted definitions are presented in the following paragraphs for clarity.

A consumer of a utility is one or more devices, controllable a unit, that use a utility and/or act as a load to the utility. So in some embodiments, a consumer may be an individual device such as a motor, but in other embodiments, a consumer may be a more complex unit that includes multiple individual utility consuming elements, such as an air conditioner. In other embodiments, the consumer may be an even more complex system such as an entire manufacturing line or even a building, as long as the utility use can be managed as a unit. The utility may be any type of utility, such as electricity, natural gas, water, or data usage, depending on the embodiment.

A gene is a data structure that describes a period of operation for a consumer of the utility. The period of operation may be described in any way that allows a determination to be made as to whether the consumer is able to consume the utility at any given time within a time period. The time period may depend on the embodiment, but may be an hour, a day, a week, a month, or a year in various embodiments, although other embodiments may choose different time periods. The consumer of the utility may be explicitly identified in the gene, or may be implicitly identified by the logical location of the gene within a chromosome, depending on the embodiment.

A chromosome is a group of genes, which may also be referred to as a vector, or a vector of operation periods. In embodiments, the chromosome may include any number of genes, but some embodiments may be implemented to include the same number of genes in all chromosomes used to solve a particular problem. Other embodiments may allow for a variable number of chromosomes by defining a default period of operation for consumers that are not identified by a gene in the chromosome. Some chromosomes may not order genes, but in some embodiments, the logical location of a gene within the chromosome may identify a particular consumer of the utility.

Mating is a process to create a new child chromosome using genes chosen from two or more existing parent chromosomes. Mutation is a process to change a gene in a chromosome or to create a new gene to replace an inherited gene. The changed or new gene is different than the genes of the parent chromosomes.

Reference now is made in detail to the examples illustrated in the accompanying drawings and discussed below.

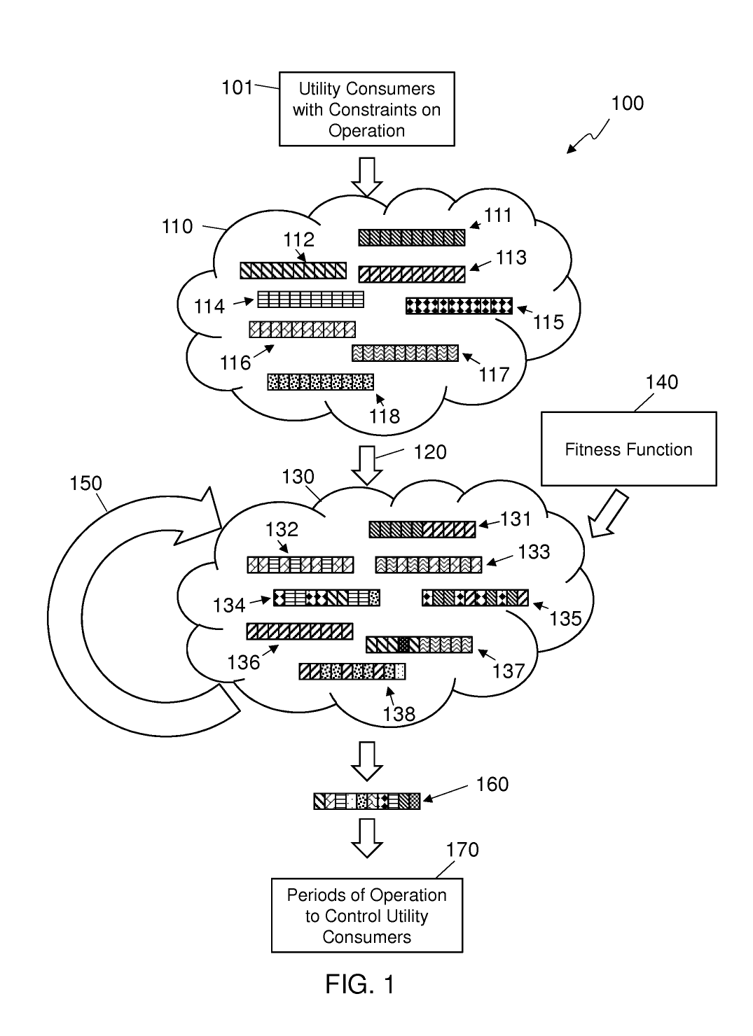

FIG. 1 is a diagram of an embodiment of evolutionary scheduling 100 of utility consumers. A list of consumers 101 of a utility to be scheduled may be obtained. Constraints for valid periods of operation for the consumers may be included in the list, or may be obtained separately. The scheduling may be done for a time period which may be any length of time but in some embodiments may be an hour, a day, a week, or a month. The constraints may provide information on an operation period that is to be used by the consumer and may include one or more pieces of information such as, but not limited to, an earliest or latest start time, an earliest or latest stop time, and a minimum or maximum duration or operation. In some embodiments, a fixed set of such parameters is included in the list for the consumers but other embodiments may include a subset of the information that may vary between consumers. If the constraints are incompatible, for example a maximum duration of 1 hour with a latest start time of 01:00 and an earliest stop time of 03:00, some embodiments may provide an error and halt, while other embodiments may ignore one or more of the constraints. In some embodiments the constraints may be given a priority that a duration constraint is highest priority, and a stop time constraint is the lowest priority, so that if incompatible constraints are obtained, the lower priority constraint(s) can be ignored. Some embodiments may have default constraints that may be used for consumers that include no constraints, so that consumers that are included on the list without constraints may still be scheduled.

A first generation 110 of chromosomes 111-118 is then created where a chromosome includes a gene for each consumer to be scheduled, and a gene represents a period of operation within a time period for a consumer of the utility. A processor may be used to randomly generate periods of operation for the consumers that were included on the list within the constraints for the consumers. Random, as used herein and in the claims, may refer to generating a truly random number, a pseudorandom number, or some other number sequence having a relatively uniform distribution even if the sequence may be easily predictable. Various techniques may be used to generate periods of operation that meet the constraints, but in some embodiments, periods within the time period being scheduled may be randomly generated and then checked against the constraints until a random period of operation is found that meets the constraints for a particular consumer.

In another embodiment, a random number is used to assign a value to a first parameter that is within the limits of the constraint for that parameter. Then a second parameter is assigned within the limits of that parameter's constraint. Because an operation period can be defined by two parameters, such as starting time and duration, starting time and ending time, or duration and ending time, once the two parameters are assigned, the solution is then checked against any remaining constraints to ensure that they are met. If the other constraints are not met, the process may be repeated until a valid period of operation is found.

In some embodiments, the constraints may be analyzed to determine if a part of the range of one of the constraints is incompatible with the other constraints. If an incompatibility is found, the constraint may be modified to reduce the possibility of a random assignment of that parameter being incompatible with the other constraints. For example, if the latest start time is 14:00 and the earliest stop time is 15:00, a minimum duration of 1:00 can be implied even if the constraint for minimum duration is less than 1:00 or is not provided. Then the parameters may be randomly assigned according to the modified constraints. In at least one embodiment, after the first parameter is assigned, the other constraints may be re-analyzed to see if some of their range is incompatible with the first parameter assignment. If it is, the other constraint(s) may be temporarily modified for the assignment of the second parameter.

One example of assigning a period of operation that is consistent with the constraints may be a consumer having constraints for a period of operation in a calendar day of earliest starting time of 02:00, minimum duration of 1:00, maximum duration of 06:00, earliest ending time of 11:00, and latest ending time of 17:00. The constraints may be analyzed and the earliest starting time may be modified to be 05:00 based on the earliest ending time and maximum duration. A latest starting time may then be implied to be 16:00 from the latest ending time and minimum duration. Then the starting time may be randomly assigned between 05:00 and 16:00, 07:39 in this example. Given a starting time of 07:39, the minimum duration may be implied from the earliest ending time to be 3:21, so the duration may then be randomly assigned between 3:21 and 6:00, 4:18 in this example, which generates an ending time of 11:57. The period of operation starting at 07:39 having a duration of 4:18 that ends at 11:57 may then be checked against all the constraints provided, and found to be a valid assignment.

Once the periods of operation for the consumers have been generated, genes representing the periods of operation are formed. The genes may include two or more of starting time, duration, and ending time and may include an identifier of the consumer in some embodiments. In at least one embodiment, a gene includes a predetermined set of two of the three possible parameters, such as starting time and ending time, for each gene. In some embodiments, the consumer is not explicitly identified in the gene but is implied by the location of the gene in a chromosome. A gene can be represented by any type of a data structure, but in at least one embodiment, the gene may include a 32 or 64 bit number to hold the media access controller (MAC) address of the consumer, a 16 or 32 bit number representing the number of minutes after midnight that the period of operation starts, and a 16 or 32 bit number representing the number of minutes after midnight that the period of operation ends.

A chromosome is a vector including two or more genes. A chromosome can be represented by any type of data structure, but may be an array of objects in some embodiments, where the objects are defined to represent a gene. Other embodiments may use a linked list of genes, or some other data structure.

The first generation 110 of chromosomes may include any number of chromosomes. Although 8 chromosomes 111-118 are shown in FIG. 1, embodiments may generate many more chromosomes for the first generation, with some embodiments generating hundreds, thousands, or even more chromosomes. The various chromosomes 111-118 of the first generation 110 may be mated 120, using a processor, to produce a successive generation 130 of chromosomes. The mating 120 may use any number of parent chromosomes 111-118 to produce a child chromosome 131-138, with some embodiments using two parent chromosomes to produce a child chromosome. The successive generation 130 may include any number of chromosomes with some embodiments increasing the number of chromosomes each generation and others maintaining a stable population of chromosomes from generation to generation. In some embodiments, the number of child chromosomes produced may be randomized.

In at least one embodiment the mating of chromosomes may include selecting a first set of genes for a chromosome of the successive generation of chromosomes from a first chromosome of the previous generation, and selecting a second set of genes for the chromosome of the successive generation of chromosomes from a second chromosome of the previous generation. In that embodiment the first chromosome of the previous generation and the second chromosome of the previous generation are chosen randomly for each chromosome of the successive generation.

Some embodiments may use a first set of genes from a first parent and a second set of genes from a second parent, where the size and location of the sets of genes may be fixed for an embodiment or may be randomly selected for each mating. In the embodiment shown, chromosome 131 may inherit its first five genes from chromosome 111 and its remaining genes from chromosome 113. Some embodiments may randomly select two parental chromosomes and then randomly select one of the parents to contribute a particular gene for the child chromosome. Chromosome 132 inherits its first, second, fourth, sixth, seventh, ninth and tenth gene from chromosome 116 and its third, fifth, and eighth gene from chromosome 114, and chromosome 133 inherits its first, second, fourth, fifth, seventh and ninth gene from chromosome 117 and its third, sixth, eighth and tenth gene from chromosome 116.

Some embodiments may choose the parental chromosomes randomly for each child chromosome and may choose the number or parents randomly. Chromosome 134 inherits its first, fourth, and fifth gene from chromosome 115, its second, third, eighth, and ninth gene from chromosome 114, its sixth and seventh gene from chromosome 112 and its tenth gene from chromosome 118, so child chromosome 134 has four parental chromosomes. Chromosome 135 inherits is first, fourth, sixth, and eighth gene from chromosome 115, its second, third, seventh, and ninth gene from chromosome 111, and its fifth and tenth gene from chromosome 113.

In some embodiments, at least some of the previous generation of chromosomes may be included in the successive generation of chromosomes. This may be equivalent to generating a child chromosome with a single parent. Chromosome 136 inherits all of its genes from chromosome 113. In some embodiments, all of the chromosomes of the previous generation are included in the successive generation.

Some embodiments may include mutating one or more chromosomes of the successive generation of chromosomes. The mutating may be done as a part of the mating or may be accomplished as a separate process to the successive generation 130 after it has been created. Mutating a chromosome makes a change to one or more genes in that chromosome within the constraints for that gene. Some embodiments may include obtaining a mutation rate and calculating a number of mutations for a generation based the mutation rate. In some embodiments, the mutating may change an existing gene by a random amount the constraints for that consumer. Other embodiments may generate a new gene, within the constraints for that consumer, without regard for the previous parental genes for that consumer. Chromosome 137 may have been produced by a mating of parental chromosome 112 and parental chromosome 117 with each contributing half of their genes, but the fourth gene of chromosome 137 has been mutated to have a period of operation that was not inherited from either parental gene. Parental chromosome 113 and parental chromosome 118 may have mated to produce child chromosome 138, but its tenth gene was mutated.

A fitness function 140 is used to evaluate and select which chromosomes of a successive generation 130 are to be used as parents in producing another successive generation, so embodiments include evaluating the chromosomes of the successive generation of chromosomes according to the fitness function. A utility usage for the consumers may also be obtained although some embodiments may include the utility usage for the consumers in the list of utility consumers 101. A fitness function may be any function to evaluate a chromosome, but in some embodiments, the fitness function may be based, at least in part, on a peak utility usage, a total utility usage, or a total cost based on a cost of the utility that varies between intervals of the time period. In some embodiments, the fitness function may include a random factor to randomly raise or lower the fitness function value of a chromosome.

In one embodiment, the fitness function may be a sum of the total utility usage multiplied by the peak utility usage. So to calculate the fitness function for a particular chromosome, the total utility usage of the ten consumers during the scheduled time period may be calculated, and a peak utility usage for any time during the scheduled time period determined based on the genes in a particular chromosome. Then the fitness function for that particular chromosome may be calculated by multiplying the sum of the ten consumers' utility usage for the particular chromosome by the peak utility usage for the particular chromosome. This may be repeated for each chromosome of the successive generation 130. For this fitness function chromosomes having a lower fitness function score may be used to generate a successive generation, although other fitness functions may be defined where a higher score is used to select chromosomes.

In another embodiment, the fitness function may be a total cost of the utility for the scheduled time period. A cost schedule for the utility may be obtained that describes the cost for the utility during different cost periods over the scheduled time period. So for example if the scheduled time period is a calendar day, and the utility being consumed is electricity, the cost schedule may include the following data: 00:00-05:00:$0.05/kW-hr; 05:00-13:00:$0.10/kW-hr; 13:00-21:00:$15.00/kW-hr; 21:00-24:00:$0.10. The fitness function may then be calculated for a particular chromosome by summing the cost of the utility usage for the ten consumers based on the consumers' utility usage and the cost of that usage for the operating time period. If the operation period spans more than one period of the cost schedule, the operation period may be broken into multiple segments that are individually multiplied by the cost for the individual cost periods and then added to calculate the total cost. For this fitness function chromosomes having a lower fitness function score may be used to generate a successive generation.

Once the fitness function has been calculated for a successive generation 130, a subset of the successive generation 130 of chromosomes 131-138 is selected to be used for producing a next successive generation. That means that only some of a successive generation 130 may be used as parental chromosomes to produce the next generation. In at least one embodiment, a number of child chromosomes in the successive generation equal or greater than the number of parental chromosomes is produced, and then the parental chromosomes are included to the successive generation. Once the fitness function of the successive generation is calculated, a stable population is maintained by deleting the chromosomes with the highest scoring fitness functions (or lowest, depending on the fitness function) until the number of chromosomes of the successive generation is equal to the number of parental chromosomes. Other embodiments may delete a random number of chromosomes scoring the highest on the fitness function and may grow or shrink the population of chromosomes between generations.

In some embodiments, the fitness function may be calculated and used to select parental chromosomes instead of removing child chromosomes. In at least one embodiment, the probability of selecting a particular chromosome for mating in producing a successive generation may be based on its fitness function score. In some embodiment, the mapping of a fitness function score to a probability of mating may be non-linear.

Additional generations of chromosomes may be produced 150 using similar methods as described above. Each successive generation is used as parental chromosomes for the next successive generation. Any number of generations may be produced. In some embodiments, the number of generations produced may be predetermined, such as 1000 generations, although other embodiments may use any fixed number or a random number. In some embodiments, successive generations are produced until at least one chromosome is produced that meets a predetermined score for the fitness function. In other embodiments, a number of successive generations is based on a magnitude of change in the fitness function of the chromosomes between generations. In one such embodiment, the score of the chromosome having lowest scoring fitness function for a generation is compared to the lowest score of the previous generation, and if the difference is less than a predetermined amount, no more generations are produced. In another such embodiment, the difference in the lowest fitness function score between generations is tracked, and if the difference is less than a predetermined value, no more generations are produced. Any algorithm may be used to determine whether or not produce another successive generation of chromosomes. Once a determination is made to not produce another generation, the last generation produced may be referred to as the descendant generation of chromosomes, so a descendant generation of chromosomes is created, and the descendant generation of chromosomes is a successive generation of chromosomes.

A chromosome 160 of the descendant generation of chromosomes is then selected based on the fitness function. In some embodiments the chromosome of the descendant generation having the lowest fitness score (or highest, depending on the fitness function) may be selected, although some embodiments may randomly choose a chromosome of the descendant generation where the probability is based on the fitness function scores of the chromosomes. The periods of operation 170 from the genes of the selected chromosome 160 are then provided over a computer communication medium to control operation of the consumers of the utility.

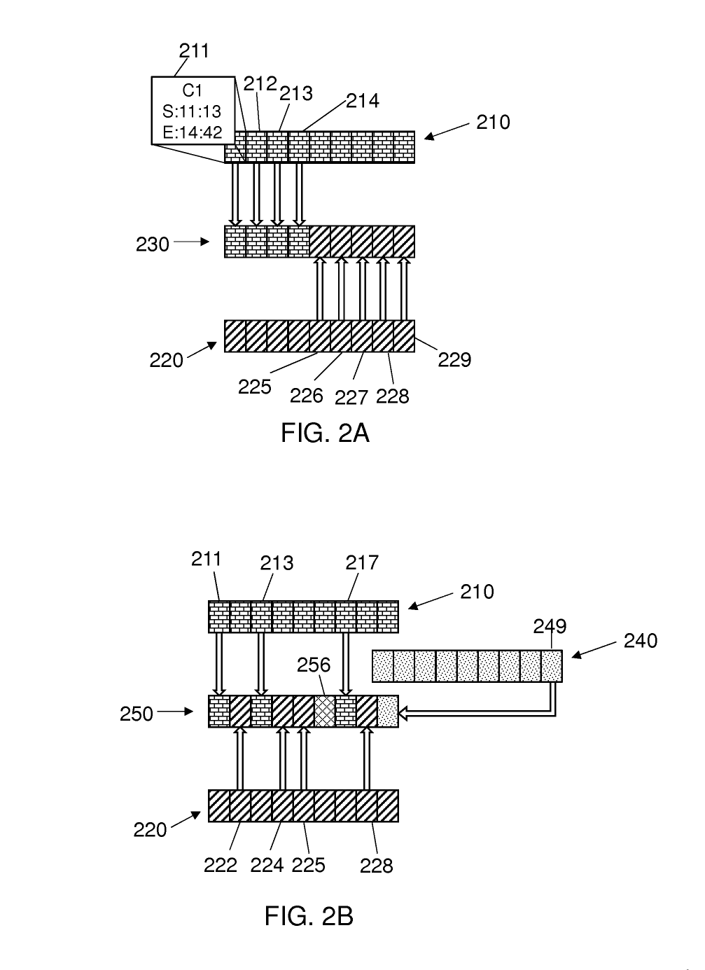

FIG. 2A and 2B shows example embodiments of mating parent vectors to create a child vector. FIG. 2A shows an example embodiment of mating of two parent vectors, or chromosomes, 210, 220 to create a child vector 230. The three vectors 210, 220, 230 may include any number of individual genes, but in the example shown, 9 genes are included in each of the vectors 210, 220, 230. The genes include information to describe an operation period for a consumer of a utility. Gene 211 is shown in more detail as an example, and includes an identifier of the utility consumer C1 as well as starting and ending times for the operation period of the consumer C1. As described earlier, a gene may be stored in any type of a data structure, and the chromosome may also be any type of data structure, but may be an array of gene objects in some embodiments.

The first parental chromosome 210 and the second parental chromosome 220 may be randomly chosen from a generation of chromosomes to be mated, although some embodiments may use a probability function based on the fitness function for the random choosing, and other embodiments may use a deterministic algorithm to choose the parental chromosomes 210, 220. Once the parental chromosomes 210, 220 are selected, one embodiment of mating may choose the first n genes from the first parental chromosome 210 and the remaining genes from the second parental chromosome 220, where n may be randomly selected.

In the example of FIG. 2A, n is randomly selected to be 4, so the first gene 211, the second gene 212, the third gene 213 and the fourth gene 214 are passed from the first parental chromosome 210 to the child chromosome 230. The fifth gene 225, sixth gene 226, seventh gene 227, eighth gene 228 and ninth gene 229 are passed from the second parental chromosome 230 to the child chromosome 230.

FIG. 2B shows an alternative embodiment of mating parental vectors, or chromosomes. The alternative embodiment used three parental vectors 210, 220, 240. In some embodiments, the number of parental vectors may be fixed, while in other embodiments the number of parental vectors may be randomly selected. The ten genes of the child vector 250 may be inherited from a randomly selected parent vector. In the example shown, the operation period for the first consumer 211, or first gene, the operation period for the third consumer 213, and the operation period for the seventh consumer 217 of the first parental vector 210, the operation period for the second consumer 222, the operation period for the fourth consumer 224, the operation period for the fifth consumer 225, and the operation period for the eighth consumer 228 of the second parental vector 220, and the operation period for the ninth consumer 249 of the third parental vector 240 are inherited by the child vector 250.

The operation period of the sixth consumer 256 is a mutation that is not inherited from any of the parental vectors 210, 220, 240. While the mutation is shown with a mating method that randomly chooses operation periods from multiple parent vectors, mutation may be included with any mating method, and in some embodiments may be used where the mating method is replication of parent vectors.

The mutation may be generated at a rate determined by a mutation rate. The mutation rate may be obtained from a user, included as a parameter of the method, or may itself be randomly generated. The mutation rate may be variable between generations or may be fixed. In at least one embodiment, the mutation rate may be modeled as a probability function of a mutation for each period of operation, or gene, passed to a child vector. One embodiment may determine whether or not to mutate a particular gene by comparing a random number having a value between zero and one to the mutation rate, and if the random number is less than or equal to the mutation rate, mutating the gene. So for an example if 1000 child vectors respectively having 10 periods of operation are being produced for a generation, and the mutation rate is set at 0.1%, about ten periods of operation may be mutated, but more or fewer mutations may be made depending on the specific random numbers generated.

A mutation may be made in any way that creates a new operation period that is consistent with the constraints for a particular consumer. If the constraints for a particular consumer provide no variability, for example a constraint set of the earliest and latest starting time both being 08:00 and the minimum and maximum duration both being 1:00, then no mutation is possible for operation periods of that consumer. In some embodiments, an operation period from one of the parental vectors may be modified by the mutation, for example by adjusting the starting time by a random number of minutes and/or the ending time by a random number of minutes, but the adjustment is checked against the constraints before being used in the child vector. In other embodiments, a new operation period that is consistent with the constraints may be generated and used in the child vector as the mutation.

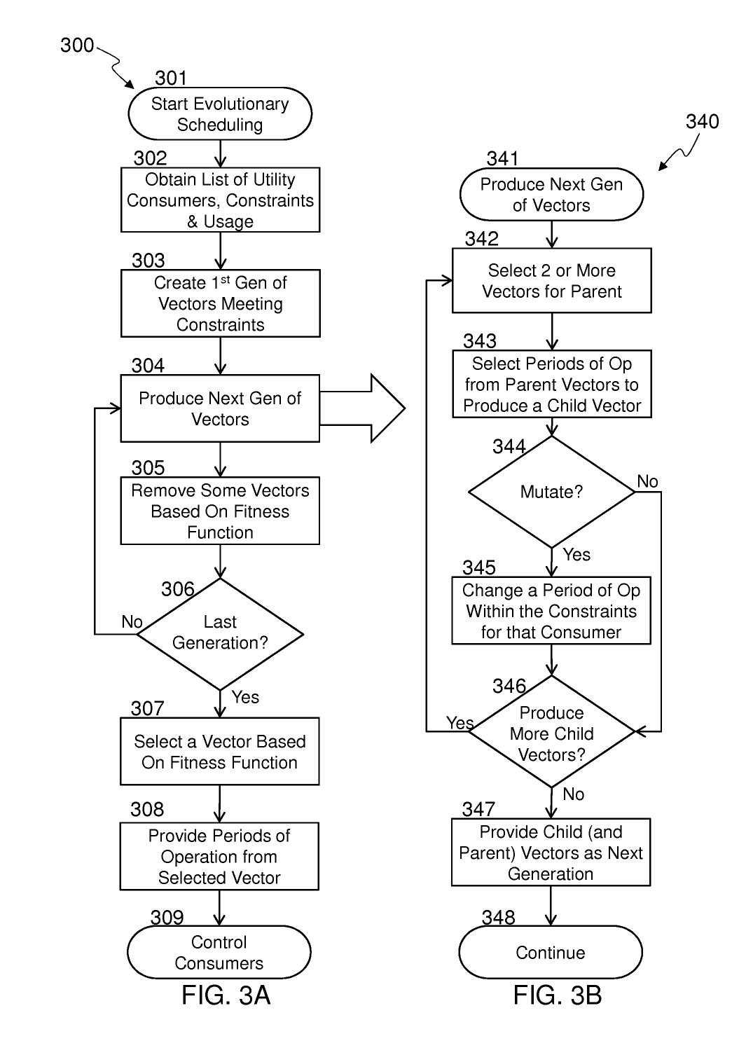

FIG. 3A is a flowchart 300 of an example method of evolutionary scheduling of utility consumers. The computer-based method to schedule utility consumers starts at block 301 and continues at block 302 by obtaining a list of utility consumers to be scheduled. In some embodiments constraints for valid operation periods for the consumers of the utility and utility usage information for the consumers may also be obtained. In some embodiments cost information on the utility may also be obtained, including cost variation over different intervals within the time period to be scheduled.

Constraints may provide limits to define valid operation periods for the consumers to be scheduled and may be provided in any form, depending on the embodiment. If the constraints are not consistent with each other, some constraints may be ignored or an error may be generated, depending on the embodiment.

The flowchart 300 continues by creating a first generation of vectors using a processor at block 303, where a vector describes operation periods within a time period for consumers of a utility. In some embodiments the first generation of vectors may be created by randomly generating operation periods for the consumers of the utility within the constraints. The operation periods may define a particular period within a time period to be scheduled. The time period to be scheduled may be any period of time but in some embodiments, the time period is selected from a group consisting of an hour, a day, a week and a month.

At block 304 the method produces a next generation, or successive generation, of vectors from the first generation of vectors. The production of a successive generation of vectors may be performed by repeatedly mating two or more vectors of the first generation to produce a child vector. Some embodiments of mating may include choosing operation periods for consumers of the utility for vectors of the child generation from vectors of a parental generation. One embodiment of producing a successive generation of vectors is described in more detail in FIG. 3B.

A fitness function may describe any algorithm for evaluating a solution to the scheduling problem but for some embodiments, the fitness function may be based, at least in part, on a total cost, a total utility usage, or a peak utility usage. In at least one embodiment, the fitness function is based on a total cost over the time period, which may provide for different results that total utility usage if the cost of the utility varies between intervals of the time period.

Once a successive generation of vectors has been produced, the successive generation of vectors may be evaluated using the fitness function and some of the successive generation of vectors may be removed at block 305. So the producing of a successive generation of vectors may include evaluating the vectors of the child generation of vectors according to the fitness function, and removing one or more of the vectors of the child generation of vectors based on the evaluating according to the fitness function. At block 306 a determination is made as to whether another generation of vectors is to be produced. If so, another successive generation of vectors is produced at block 304 using the previous successive generation as parental vectors.

It may be determined at block 306 that no more successive generations should be produced. This determination may be made based on an evaluation of the successive generations using the fitness function in some embodiments. The lowest fitness function value of each generation of vectors may be determined and some embodiments may stop producing a new generation when a predetermined fitness function value is attained by at least one vector. Other embodiments may stop producing successive generations based on differences in the lowest fitness function value between generations. In other embodiments, a predetermined number of successive generations are produced to create the descendant generation. The last successive generation produced may be referred to as the descendant generation. So one or more successive generations of vectors may be produced, using a processor, from the first generation of vectors to create a descendant generation of vectors.

A vector of the descendant generation of vectors may be selected 307 based on the fitness function. The vector having the lowest fitness function value (or highest, depending on the fitness function) may be selected in many embodiments, although other embodiments may randomly choose a vector based on the fitness function values. Once the vector has been selected, operation periods from the vector of the descendant generation of vectors are provided at block 308 over a computer communication medium to control operation of the consumers of the utility at block 309. The consumers of the utility may operate for the entire duration of their operation periods in some embodiments, although in other embodiments, the consumer may determine what portion of its operation period to utilize based on other factors. For example, a heating or air conditioning unit may be given an operation period of 06:00 to 22:00 but may be further controlled by a local thermostat so that it only operates for a portion of the operation period. In other embodiments, the operation period may be taken as a guideline with ultimate control of when the consumer operates left to the consumer or some other controller of the consumer, with the operation period taken into consideration.

FIG. 3B is a flowchart 340 of an example method starting at block 341 to produce a next generation of vectors. The flowchart 340 is an embodiment that may be used for block 304 of the flowchart 300 of FIG. 3A. Two or more vectors of a parental generation are selected at block 342. The parental vectors may be chosen randomly from the parental generation in some embodiments and/or the parental vectors may be chosen, at least in part, based on their fitness function value. At block 343 an operation period is selected from one of the selected parental vectors for each of the consumers to be scheduled. The selection of the operation periods from the selected parental vectors may be performed by any method, but in some embodiments, the selection is done by choosing the operation periods for the consumers of the utility from randomly chosen vectors of the parental generation. In various embodiments a vector of the child generation includes operation periods chosen from at least two different vectors of the parental generation, and in some embodiments a vector of the child generation comprises operation periods chosen from three or more different vectors of the parental generation.

In another embodiment the choosing of the operation periods includes selecting a consumer of the utility, which may be done randomly. A first vector of the parental generation and the second vector of the parental generation may also be chosen randomly. A period of operation for the selected consumer of the utility in a vector of the child generation may be chosen from the first vector of the parental generation, and operation periods for consumers of the utility positioned after the selected consumer of the utility in the vector of the child generation may also be chosen from the first vector of the parental generation. Operation periods for consumers of the utility positioned before the selected consumer of the utility in the vector of the child generation may then be chosen from the second vector of the parental generation.

The flowchart 340 then continues by deciding in block 344 whether one or more mutation to the child vector should be made. Some embodiments may obtain a mutation rate that may be used for the determination in block 344. In at least one embodiment, a random number ranging from zero to one may be obtained for each operation period, or gene, and compared to the mutation rate. If the random number is greater than the mutation rate, then no mutation of the operation period is made and the flowchart 340 continues to block 346. If the random number is less than or equal to the mutation rate, the operation period is changed, or mutated, at block 345, so the number of changes made in one generation is based on the mutation rate.

A mutation may be made in one or more operation periods in block 345. One way of producing a mutation may involve changing an operation period for at least one consumer of the utility in at least one vector of the child generation. The change may be based on an inherited operation period but because the change may put the operation period outside of its constraints, the changed operation period is checked against the constraints and if outside those constraints, modified again until the results of the changing are within the constraints. Another way of producing a mutation may involve creating a new random operation period within the constraints to be used for the operation period.

A decision is made at block 346 whether to produce more child vectors. The number of child vectors produced may vary between embodiments. In some embodiments, the number of vectors produced for a child generation may be based on the number of vectors included in the parental generation, with at least one embodiment producing a number of child vectors equal to the number of vectors of the parental generation. In some embodiments, a fixed number of child vectors may be produced for each generation, while other embodiments may use a random number to determine a number of child vectors.

Once enough child vectors have been produced, the child generation of vectors may be provided at block 347 before the flowchart 340 terminates at block 348 and allows the overall method to continue. Some embodiments may add vectors from the parental generation of vectors to the child (or next) generation of vectors before providing the child generation. In some embodiments, all the parental generation vectors are included in the child generation, but other embodiments may include only those vectors used as parents for a child, a subset of the parental generation based on the fitness function, or a random selection of the parental generation.

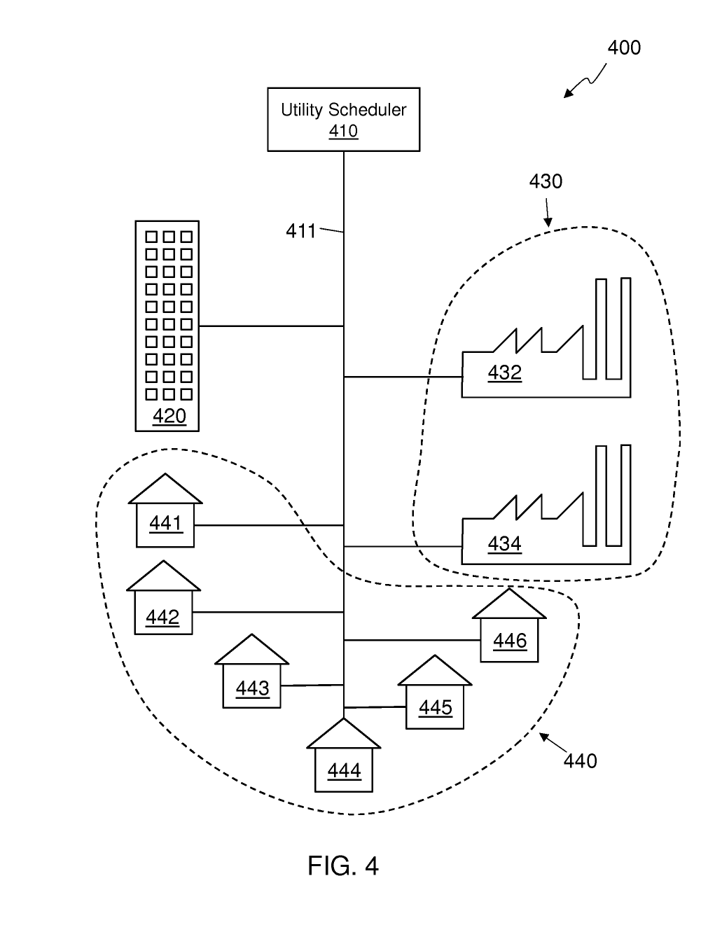

FIG. 4 is a diagram of a system 400 for an embodiment of evolutionary scheduling of utility consumers at a utility level. A utility scheduler 410 may be controlled by a utility provider or some other entity and may include a computer that implements one or more of the methods for evolutionary scheduling of utility consumers described herein. The utility provider may have one or more business utility consumers 420, one or more industrial utility consumers 430, and/or one or more home utility consumers 440. A computer communication medium 411 may be used to communicate between the utility scheduler and the various consumers. The computer communication medium 411 may be a wireless network such as a cellular communication network, a powerline network that uses the wiring of the power grid for the communication medium 411, an internet connection, or any other type of communication medium, a wired, wireless or hybrid network.

Some of the consumers may contract with the utility provider to allow the utility scheduler 410 to control their operation times in exchange for lower utility rates or other consideration. This may be helpful for the utility provider to avoid peak loads, so a fitness function designed to minimize peak usage may be used. For example homeowners 441-446 may allow the utility provider to control operation times of certain utility consumers within the home such as a hot water heater and/or air conditioner which may be then be controlled separately by the utility scheduler 410. The utility provider may install a power controller for those devices in the home that is in communication with the utility scheduler 410 over the communication medium 411. For example the homeowner may provide an internet connection to the power controller which then communicates with the utility scheduler 410 over the internet.

An industrial customer 432-434 may have individual devices that may be controlled by the utility scheduler 410, such as large motors, compressors, or pumps, as well as air conditioners, heaters or other large utility users that the industrial customer may allow to be controlled individually or as a group, such as all the equipment of an assembly line. The industrial customer may ask for advance notice of the operation periods assigned by the utility provider to allow for planning. In some embodiments, the communication between the utility scheduler 410 and the consumers within the industrial customer may be automated, but in other embodiments, control of at least some of the consumers in the industrial customer may include some manual control.

A business customer 420 may provide the utility provider with the capability to control heating, ventilation, and air conditioning (HVAC) equipment as well as lighting, power for elevators, or other consumers of the utility. In at least some embodiments, control of some consumers in a business customer may involve some amount of manual control.

The business customer 420, industrial customers 432-434 and/or homeowners 441-446 may provide the utility provider with constraints for their utility consumers. The constraints may be negotiated between the customer and the utility provider or may be set by the utility provider so that a customer can choose to opt-in or not. In some embodiments, a utility provider may set constraints in their terms of service for certain customers. The utility provider may determine a time period, such as a calendar day to be scheduled and use the evolutionary scheduling methods described herein to create operation periods for each of the consumers. The operation periods are then provided from the utility scheduler 410 over the communication medium 411 to control the operation of the consumers. In some embodiments, the consumers are not able to operate outside their assigned operation periods and may not operate for the entire operation period assigned to them, depending on local controllers such as thermostats for more fine-tuned control. In some embodiments, consumers may operate outside of their assigned operation periods, but may pay a higher rate for doing so.

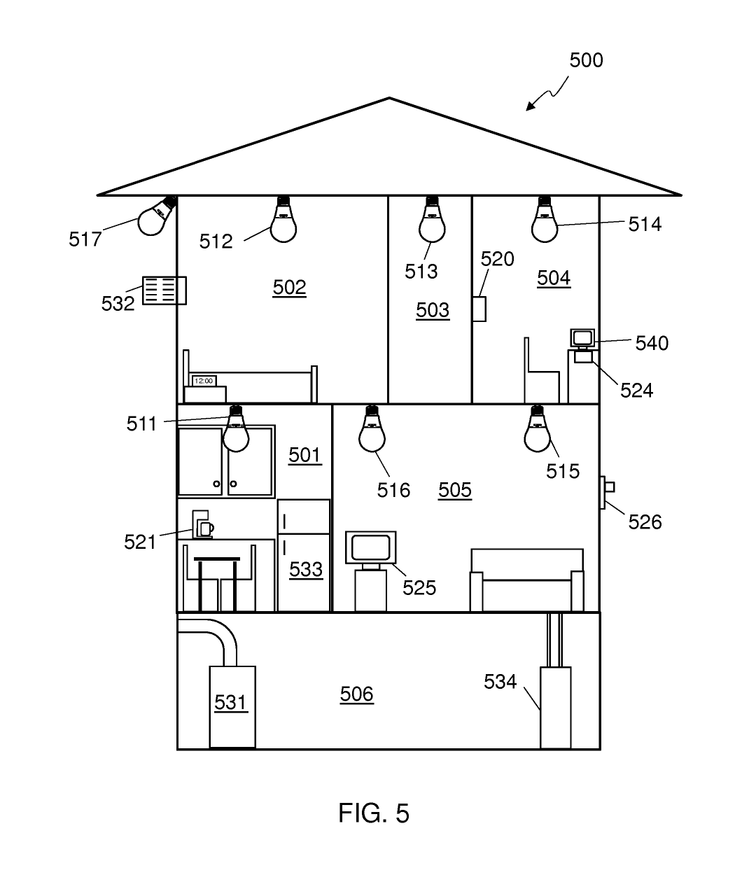

FIG. 5 shows a stylized view of a home 500 for use with an embodiment of evolutionary scheduling of utility consumers. The home 500 includes networked devices that communicate over home network. The home network may be any type of home network including a wired network such as Ethernet, or wireless network. The wireless network may be a wireless mesh network such as Z-wave or Zigbee (IEEE 802.15.4). Other wireless networks such as Wi-Fi (IEEE 802.11) might be used in some embodiments, and some embodiments may utilize a heterogeneous network with multiple types of networks. The home 100 has six rooms shown. The kitchen 501 has a networked light fixture 511, a networked coffee maker 521 and a refrigerator 533. The bedroom 502 has a networked light fixture 512, and an air conditioner 532. The hallway 503 has a networked light bulb 513. The home office 504 has a networked light fixture 514, a power controller 520, and a home computer 540 connected to a network gateway 524 to allow the computer 540 to communicate with devices on the home network. The living room 505 has two networked light fixtures 515, 516 and a networked television 525. The basement 506 has a furnace 531 and a hot water heater 534. External to the home is a networked floodlight 517 and a networked electric meter 526.

In an embodiment, an evolutionary scheduling program may be installed on the computer 540 which the user may configure to generate operation periods for major consumers of a utility, such as the air conditioner 532, the furnace 531, the hot water heater 534 and the refrigerator 533. In some embodiments, the major consumers 531-534 may be networked to allow their operation to be controlled through a network connection, but in other embodiments, the consumers 531-534 may be controlled by the power controller 520. The power controller may receive the operation periods from the computer 540 and control individual power connections to the consumers 531-534. In some embodiments, the homeowner may also configure the evolutionary scheduling program to control one or more other networked devices 511-525 that may consume smaller amounts of the utility. For the smaller utility consumers, the program may be set up to control the consumers as a group.

The homeowner may configure the program with constraints for the various devices to ensure that the device is still useful, yet may still allow for scheduling to reduce their utility bill. In one embodiment the time period for scheduling may be one hour so that each consumer is given one operation period per hour so that the temperature won't stray too far from the desired temperature. So the furnace 531 or the air conditioner 532 may be given a constraint to allow for one of them to have an operation period of at least 20 minutes, depending on the time of year. The hot water heater may be given a constraint to have an operation period of at least 15 minutes and the refrigerator 533 a constraint to have an operation period of at least 15 minutes. Other major consumers, such as a clothes washer, clothes dryer, dish washer, and dehumidifiers may also be included in the control and have their own set of constraints defined. Utility usage for the various major consumers may be entered into the program by the user, or in some embodiments, may be determined by communicating with the networked utility meter 526 or by querying the consumer directly. Cost of the utility may be entered in manually or may be received from the utility provider over an internet connection or through the networked utility meter 526. The evolutionary scheduling software on the computer 540 may then provide schedules for the various consumers of the utility to attempt to minimize the total cost of the utility for the homeowner.

In embodiments, the techniques and methods described herein may be implemented using computer code running on a processor, but in some embodiments, parts of one or more block, all one or more block, or all of the blocks of the methods shown may be implemented using other circuits or other computers that are a part of a utility scheduling system. In some embodiments, the methods may be embodied as a computer program product with computer code stored on a non-transitory computer readable medium.

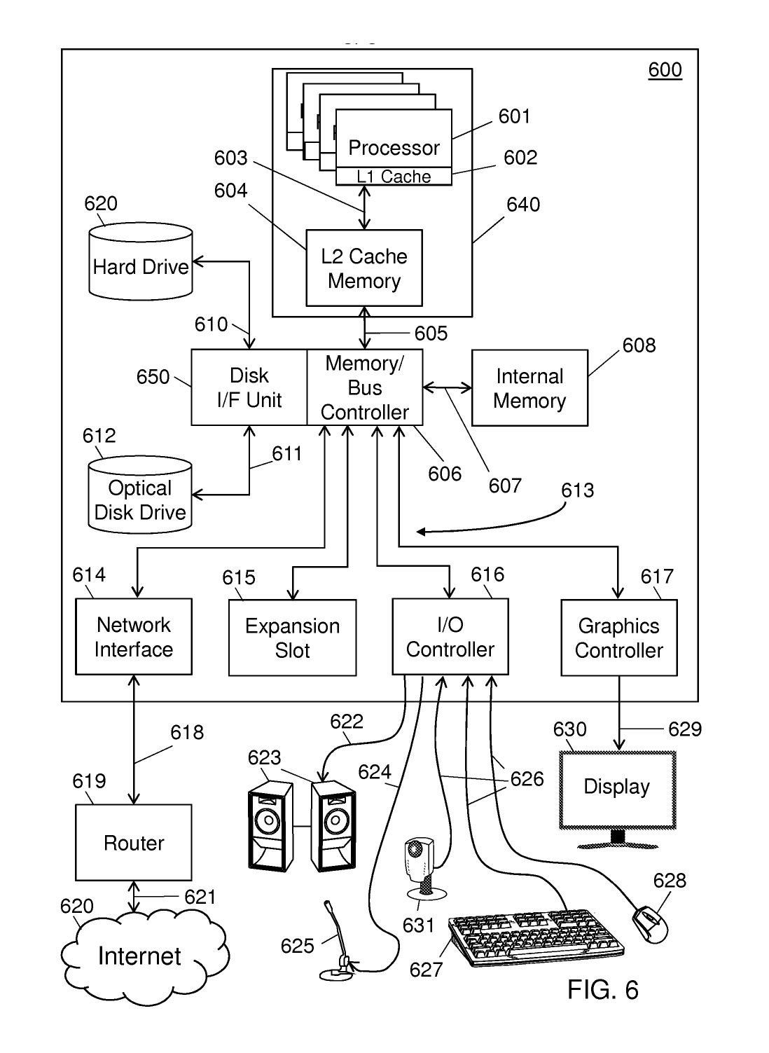

FIG. 6 depicts details of a computer system 600 suitable for various embodiments. The computer system 600 may be located anywhere, but may be in a home, business or factory in some embodiments. In other embodiments, the computer system 600 may be controlled by a provider of a utility. The computer system 600 may store computer program code to perform any of the techniques or methods described herein.

The computer system 600 may be configured in the form of a desktop computer, a laptop computer, a mainframe computer, or any other hardware or logic arrangement capable of being programmed or configured to carry out instructions. In some embodiments the computer system 600 may act as a server, accepting inputs from a remote user over a local area network (LAN) 618 or the internet 620. In other embodiments, the computer system 600 may function as a smart user interface device for a server on a LAN 618 or over the internet 620. The computer system 600 may be located and interconnected in one location, or may be distributed in various locations and interconnected via communication links such as a LAN 618 or a wide area network (WAN), via the Internet 620, via the public switched telephone network (PSTN), a switching network, a cellular telephone network, a wireless link, or other such communication links. Other devices may also be suitable for implementing or practicing the embodiments, or a portion of the embodiments. Such devices include tablets, wireless handsets (e.g., a cellular telephone or pager), and other such electronic devices preferably capable of being programmed to carry out instructions or routines. One skilled in the art may recognize that many different architectures may be suitable for the computer system 600, but only one typical architecture is depicted in FIG. 6.

Computer system 600 may include a processor 601 which may be embodied as a microprocessor, two or more parallel processors, a central processing unit (CPU) or other such control logic or circuitry. The processor 601 may be configured to access a local cache memory 602, and send requests for data that are not found in the local cache memory 602 across a cache bus 603 to a second level cache memory 604. Some embodiments may integrate the processor 601, and the local cache 602 onto a single integrated circuit and other embodiments may utilize a single level cache memory or no cache memory at all. Other embodiments may integrate multiple processors 601 onto a single die and/or into a single package. Yet other embodiments may integrate multiple processors 601 with multiple local cache memories 602 with a second level cache memory 604 into a single package 640 with a front side bus 605 to communicate to a memory/bus controller 606. The memory/bus controller 606 may accept accesses from the processor(s) 601 and direct them to either the internal memory 608 over memory bus 607 or to the various input/output (I/O) busses 610, 611, 613. A disk interface unit 650 may connect to the communication link 610 to the hard disk drive 620 and/or or other communication link 611 to the optical disks 612 and may be integrated into the memory/bus controller 606 or may be a separate chip. Some embodiments of the computer system 600 may include multiple processor packages 640 sharing the front-side bus 605 to the memory/bus controller. Other embodiments may have multiple processor packages 640 with independent front-side bus connections to the memory/bus controller 606. The memory bus controller 606 may communicate with the internal memory 608 using a memory bus 607. The internal memory 608 may include one or more of random access memory (RAM) devices such as synchronous dynamic random access memories (SDRAM), double data rate (DDR) memories, or other volatile random access memories. The internal memory 608 may also include non-volatile memories such as electrically erasable/programmable read-only memory (EEPROM), NAND flash memory, NOR flash memory, programmable read-only memory (PROM), read-only memory (ROM), battery backed-up RAM, or other non-volatile memories. The various memory devices may be embodiments of a non-transitory computer readable storage medium suitable for storing computer program code and/or data. In some embodiments, the computer system 600 may also include 3rd level cache memory or a combination of these or other like types of circuitry configured to store information in a retrievable format. In some implementations the internal memory 608 may be configured as part of the processor 601, or alternatively, may be configured separate from it but within the same package 640. The processor 601 may be able to access internal memory 608 via a different bus or control lines than is used to access the other components of computer system 600.

The computer system 600 may also include, or have access to, one or more hard disk drives 620 (or other types of storage memory) and optical disk drives 612. Hard disk drives 620 and the optical disks for optical disk drives 612 are examples of non-transitory machine readable (also called computer readable) mediums suitable for storing computer program code and/or data. The optical disk drives 612 may include a combination of several disc drives of various formats that can read and/or write to removable storage media (e.g., CD-R, CD-RW, DVD, DVD-R, DVD-W, DVD-RW, HD-DVD, Blu-Ray, and the like). Other forms or computer readable media that may be included in some embodiments of computer system 600 include, but are not limited to, floppy disk drives, 9-track tape drives, tape cartridge drives, solid-state drives, cassette tape recorders, paper tape readers, bubble memory devices, magnetic strip readers, punch card readers or any other type or computer useable storage medium. The computer system 600 may either include the hard disk drives 620 and optical disk drives 612 as an integral part of the computer system 600 (e.g., within the same cabinet or enclosure and/or using the same power supply), as connected peripherals, or may access the hard disk drives 620 and optical disk drives 612 over a network, or a combination of these. The hard disk drive 620 often includes a rotating magnetic medium configured for the storage and retrieval of data, computer programs or other information. The hard disk drive 620 also often includes a disk controller capable of controlling the motor to rotate the storage medium as well as access the data on the medium. In some embodiments, an additional drive may be a solid state drive using semiconductor memories. In other embodiments, some other type of computer useable medium may be used. The hard disk drive 620 need not necessarily be contained within the computer system 600. For example, in some embodiments the hard disk drive 620 may be server storage space within a network that is accessible to the computer system 600 for the storage and retrieval of data, computer programs or other information. In some instances the computer system 600 may use storage space at a server storage farm, or like type of storage facility, that is accessible by the Internet 620 or other communications lines. The hard disk drive 620 is often used to store the software, instructions and programs executed by the computer system 600, including for example, all or parts of the computer application program for carrying out activities of the various embodiments.

The disk interface 610 and/or communication link 611 may be used to access the contents of the hard disk drives 620 and optical disk drives 612. These interfaces/links 610, 611 may be point-to-point links such as Serial Advanced Technology Attachment (SATA) or a bus type connection such as Parallel Advanced Technology Attachment (PATA) or Small Computer System Interface (SCSI), a daisy chained topology such as IEEE-1394, a link supporting various topologies such as Fibre Channel, or any other computer communication protocol, standard or proprietary, that may be used for communication to computer readable medium.

The memory/bus controller may also provide other I/O communication links 613. In some embodiments, the links 613 may be a shared bus architecture such as peripheral component interface (PCI), microchannel, industry standard architecture (ISA) bus, extended industry standard architecture (EISA) bus, VERSAmodule Eurocard (VME) bus, or any other shared computer bus. In other embodiments, the links 613 may be a point-to-point link such as PCI-Express, HyperTransport, or any other point-to-point I/O link. Various I/O devices may be configured as a part of the computer system 600. In many embodiments, a network interface 614 may be included to allow the computer system 600 to connect to a network 618. The network 618 may be an IEEE 802.3 ethernet network, an IEEE 802.11 Wi-Fi wireless network, or any other type of computer network including, but not limited to, LANs, WAN, HAN, personal area networks (PAN), wired networks, radio frequency networks, powerline networks, and optical networks. A router 619 or network gateway, which may be a separate component from the computer system 600 or may be included as an integral part of the computer system 600, may be connected to the network 618 to allow the computer system 600 to communicate with the internet 620 over an internet connection 621 such as an asymmetric digital subscriber line (ADSL), data over cable service interface specification (DOCSIS) link, T1 or other internet connection mechanism. In other embodiments, the computer system 600 may have a direct connection to the internet 620. In some embodiments, an expansion slot 615 may be included to allow a user to add additional functionality to the computer system 600.

The computer system 600 may include an I/O controller 616 providing access to external communication interfaces such as universal serial bus (USB) connections 626, serial ports such as RS-232, parallel ports, audio in 624 and audio out 622 connections, the high performance serial bus IEEE-1394 and/or other communication links. These connections may also have separate circuitry in some embodiments, or may be connected through a bridge to another computer communication link provided by the I/O controller 616. A graphics controller 617 may also be provided to allow applications running on the processor 601 to display information to a user. The graphics controller 617 may output video through a video port 629 that may utilize a standard or proprietary format such as an analog video graphic array (VGA) connection, a digital video interface (DVI), a digital high definition multimedia interface (HDMI) connection, or any other video interface. The video connection 629 may connect to display 630 to present the video information to the user. The display 630 may be any of several types of displays, including a liquid crystal display (LCD), a cathode ray tube (CRT) monitor, on organic light emitting diode (OLED) array, or other type of display suitable for displaying information for the user. The display 630 may include one or more light emitting diode (LED) indicator lights, or other such display devices. Typically, the computer system 600 includes one or more user input/output (I/O) devices such as a keyboard 627, mouse 628, and/or other means of controlling the cursor represented including but not limited to a touchscreen, touchpad, joystick, trackball, tablet, or other device. The user I/O devices may connect to the computer system 600 using USB 626 interfaces or other connections such as RS-232, PS/2 connector or other interfaces. Some embodiments may include a webcam 631 which may connect using USB 626, a microphone 625 connected to an audio input connection 624 and/or speakers 623 connected to an audio output connection 622. The keyboard 627 and mouse 628, speakers 623, microphone 625, webcam 631, and monitor 630 may be used in various combinations, or separately, as means for presenting information to the user and/or receiving information and other inputs from a user to be used in carrying out various programs and calculations. Speech recognition software may be used in conjunction with the microphone 625 to receive and interpret user speech commands.

As will be appreciated by those of ordinary skill in the art, aspects of the various embodiments may be embodied as a system, method or computer program product. Accordingly, aspects of the present invention may take the form of an entirely hardware embodiment, an entirely software embodiment (including firmware, resident software, micro-code, or the like) or an embodiment combining software and hardware aspects that may all generally be referred to herein as a “server,” “circuit,” “module,” “lighting gateway,” “logic” or “system.” Furthermore, aspects of the various embodiments may take the form of a computer program product embodied in one or more computer readable medium(s) having computer readable program code stored thereon.

Any combination of one or more computer readable storage medium(s) may be utilized. A computer readable storage medium may be embodied as, for example, an electronic, magnetic, optical, electromagnetic, infrared, or semiconductor system, apparatus, or device, or other like storage devices known to those of ordinary skill in the art, or any suitable combination of computer readable storage mediums described herein. In the context of this document, a computer readable storage medium may be any tangible medium that can contain, or store a program and/or data for use by or in connection with an instruction execution system, apparatus, or device.

Computer program code for carrying out operations for aspects of various embodiments may be written in any combination of one or more programming languages, including an object oriented programming language such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products of various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in this specification and the appended claims, the singular forms “a”, “an”, and “the” include plural referents unless the content clearly dictates otherwise. Thus, for example, reference to an element described as “a gene” may refer to a single gene, two genes or any other number of genes. As used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

Any element in a claim that does not explicitly state “means for” performing a specified function, or “step for” performing a specified function, is not to be interpreted as a “means” or “step” clause as specified in 35 U.S.C. §112, ¶6.

The description of the various embodiments provided above is illustrative in nature and is not intended to limit the invention, its application, or uses. Thus, different variations beyond those described herein are intended to be within the scope of the embodiments of the present invention. Such variations are not to be regarded as a departure from the intended scope of the present invention. As such, the breadth and scope of the present invention should not be limited by the above-described exemplary embodiments, but should be defined only in accordance with the following claims and equivalents thereof.

What is claimed is:

1. A computer-based method to schedule utility consumers comprising:
obtaining a list of consumers of a utility to be scheduled, constraints for valid periods of operation for said consumers;
creating a first generation of chromosomes by using a processor to randomly generate periods of operation within said constraints, wherein a gene represents a period of operation within a time period for a consumer of the utility and each chromosome comprises a gene for each of said consumers;
producing, using a processor, successive generations of chromosomes from the first generation of chromosomes to create a descendant generation of chromosomes, wherein the descendant generation of chromosomes is a successive generation of chromosomes;
selecting a chromosome of the descendant generation of chromosomes based on a fitness function; and
providing periods of operation from genes of said selected chromosome over a computer communication medium to control operation of the consumers of the utility;
wherein the producing the successive generations of chromosomes comprises:
mating at least two chromosomes of a previous generation of chromosomes to produce each chromosome of a successive generation of chromosomes;
mutating one or more chromosomes of the successive generation of chromosomes;
adding at least some of the previous generation of chromosomes to the successive generation of chromosomes;
evaluating the chromosomes of the successive generation of chromosomes according to the fitness function;
selecting a subset of the successive generation of chromosomes to be used for producing a next successive generation.

2. The method of claim 1, wherein the list of the consumers of the utility includes utility usage information of said consumers; and
the fitness function is based, at least in part, on a peak utility usage, a total utility usage, or a total cost based on a cost of the utility that varies between intervals of the time period.

3. The method of claim 1, wherein said mating comprises:
selecting a first set of genes for a chromosome of the successive generation of chromosomes from a first chromosome of the previous generation;
selecting a second set of genes for the chromosome of the successive generation of chromosomes from a second chromosome of the previous generation;
wherein the first chromosome of the previous generation and the second chromosome of the previous generation are chosen randomly for each chromosome of the successive generation.

4. The method of claim 1, further comprising obtaining a mutation rate; and
calculating a number of mutations based the mutation rate;
wherein said mutating comprises randomly changing said number of genes, within said constraints, in one or more chromosomes of the successive generation of chromosomes.

5. The method of claim 1, wherein a number of successive generations is based on a magnitude of change in the fitness function of the chromosomes between generations.

6. A computer-based method to schedule utility consumers comprising:
creating a first generation of vectors using a processor, wherein a vector comprises operation periods within a time period for consumers of a utility;
producing, using a processor, one or more successive generations of vectors from the first generation of vectors to create a descendant generation of vectors;
selecting a vector of the descendant generation of vectors based on a fitness function; and
providing operation periods from said vector of the descendant generation of vectors over a computer communication medium to control operation of the consumers of the utility.

7. The method of claim 6, wherein the creating the first generation of vectors comprises:
obtaining constraints for valid operation periods for the consumers of the utility; and
randomly generating operation periods for the consumers of the utility within said constraints.

8. The method of claim 6, wherein the fitness function is based, at least in part, on a total cost, a total utility usage, or a peak utility usage.

9. The method of claim 6, wherein the fitness function is based on a total cost over the time period; and
a cost of the utility varies between intervals of the time period.

10. The method of claim 6, wherein the time period is selected from a group consisting of a day, a week and a month.

11. The method of claim 6, wherein a predetermined number of successive generations are produced to create the descendant generation.

12. The method of claim 6, wherein a number of successive generations produced to create the descendant generation is dependent on an evaluation of the successive generations using the fitness function.

13. The method of claim 6, wherein the producing of a successive generation of vectors comprises:
choosing operation periods for consumers of the utility for vectors of the child generation from vectors of a parental generation.
evaluating the vectors of the child generation of vectors according to the fitness function; and
removing one or more of the vectors of the child generation of vectors based on said evaluating.

14. The method of claim 13, further comprising:
adding vectors from the parental generation of vectors to the next generation of vectors before said evaluating and said removing.

15. The method of claim 13, wherein said choosing comprises:
selecting a consumer of the utility;
choosing an operation period for the selected consumer of the utility in a vector of the child generation from a first vector of the parental generation;
choosing operation periods for consumers of the utility positioned after the selected consumer of the utility in said vector of the child generation from the first vector of the parental generation; and
choosing operation periods for consumers of the utility positioned before the selected consumer of the utility in said vector of the child generation from a second vector of the parental generation.

16. The method of claim 15, wherein the selecting the consumer of the utility is done randomly, and the first vector of the parental generation and the second vector of the parental generation are chosen randomly.

17. The method of claim 13, wherein said choosing comprises choosing the operation periods for the consumers of the utility from randomly chosen vectors of the parental generation;
wherein a vector of the child generation comprises operation periods chosen from at least two different vectors of the parental generation.

18. The method of claim 17, wherein said vector of the child generation comprises operation periods chosen from three or more different vectors of the parental generation.

19. The method of claim 13, wherein the producing of a successive generation of vectors further comprises:
obtaining constraints for valid operation periods for the consumers of the utility; and
changing an operation period for at least one consumer of the utility in at least one vector of the child generation;
wherein results of said changing are within said constraints.

20. The method of claim 19, wherein the changing the operation period comprises creating a new random operation period within said constraints to be used for the operation period.

21. The method of claim 19, further comprising obtaining a mutation rate;
wherein a number of changes made in one generation is based on the mutation rate.

22. An article of manufacture comprising a non-transitory computer readable storage medium having instructions stored thereon that, if executed by a processor, result in:
creating a first generation of vectors using a processor, wherein a vector comprises operation periods within a time period for consumers of a utility;
producing, using a processor, one or more successive generations of vectors from the first generation of vectors to create a descendant generation of vectors;
selecting a vector of the descendant generation of vectors based on a fitness function; and
providing operation periods from said vector of the descendant generation of vectors over a computer communication medium to control operation of the consumers of the utility.

23. The article of manufacture of claim 22, wherein the instructions, if executed by a processor, further result in:
obtaining constraints for valid operation periods for the consumers of the utility; and
randomly generating operation periods for the consumers of the utility within said constraints.

24. The article of manufacture of claim 22, wherein the instructions, if executed by a processor, further result in:
choosing operation periods for consumers of the utility for vectors of the child generation from vectors of a parental generation.
evaluating the vectors of the child generation of vectors according to the fitness function; and
removing one or more of the vectors of the child generation of vectors based on said evaluating.

25. The article of manufacture of claim 24, wherein the instructions, if executed by a processor, further result in adding vectors from the parental generation of vectors to the next generation of vectors before said evaluating and said removing.

26. The article of manufacture of claim 24, wherein the instructions, if executed by a processor, further result in:
selecting a consumer of the utility;
choosing an operation period for the selected consumer of the utility in a vector of the child generation from a first vector of the parental generation;
choosing operation periods for consumers of the utility positioned after the selected consumer of the utility in said vector of the child generation from the first vector of the parental generation; and
choosing operation periods for consumers of the utility positioned before the selected consumer of the utility in said vector of the child generation from a second vector of the parental generation.

27. The article of manufacture of claim 24, wherein the instructions, if executed by a processor, further result in:
obtaining constraints for valid operation periods for the consumers of the utility; and
changing an operation period for at least one consumer of the utility in at least one vector of the child generation;
wherein results of said changing are within said constraints.

28. The article of manufacture of claim 27, wherein the instructions, if executed by a processor, further result in:
obtaining a mutation rate;
using the mutation rate to determine a number of changes made in one generation.
